(19) United States
(12) Patent Application Publication
(10) Pub. No.: US 2014/0177268 A1
(43) Pub. Date: Jun. 26, 2014

(54) Optical Film Layer, Backlight Module, and Display Device

(71) Applicant: Shenzhen China Star Optoelectronics Technology Co., Ltd., Shenzhen ,Guangdong (CN)

(72) Inventor: Gege Zhou, Shenzhen City (CN)

(73) Assignee: Shenzhen China Star Optoelectronics Technology Co., Ltd., Shenzhen, Guangdong (CN)

(21) Appl. No.: 13/808,988

(22) PCT Filed: Dec. 24, 2012
(86) PCT No.: PCT/CN2012/087268

§ 371 Date: Jan. 8, 2013

(30) Foreign Application Priority Data
Dec. 20, 2012 (CN) 201210558575.6

(51) Int. Cl. F21V 11/16; F21V 8/00

(52) U.S. Cl. CPC F21V 11/16; G02B 6/005
USPC 362/606; 362/351

(57) ABSTRACT

An optical film layer, a backlight module, and a display device are proposed. A black shading district is disposed on a terminal of the optical film layer for preventing light produced by a light source from entering the optical film layer through the terminal of the optical film layer. In this way, light leakage will not happen since the light which partially enters the optical film layer is blocked off. Display quality of the display device, especially display quality of the display device having a narrow bezel is improved.

### BACKGROUND OF THE INVENTION

1. Field of the Invention

The present invention relates to display technology, and more particularly, to an optical film layer, a backlight module, and a display device.

2. Description of the Prior Art

With the development of technology, display technology makes progress faster and faster. In display technology, liquid crystal displays (LCDs) are especially important to human beings. LCDs have becomes part of human life. Nowadays, LCDs are designed with a large screen or an extra large screen, which is a symbol of fashion and beauty. Such a fashionable and beautiful design not only brings a better visual experience for human beings but also becomes a fashionable and beautiful decoration. To produce a large LCD screen or an extra large LCD screen, the conventional technology adopts a method of designing a narrower frame or further a narrower housing. However, an optical film cannot be pressed and fixed firmly using the narrower housing. As a result, light produced by light sources partially enters the optical film and then goes outside very easily. Light leakage thus occurs.

### SUMMARY OF THE INVENTION

An object of the present invention is to provide an optical film layer, a backlight module, and a display device for preventing light generated by a light source from partially entering the optical film layer. In this way, no light leakage happens, which improves display quality of the display device, especially display quality of the display device comprising a narrow bezel.

According to the present invention, an optical film layer comprising a terminal on which a black shading district is disposed is proposed to prevent light produced by a light source from entering the optical film layer through the terminal.

In one aspect of the present invention, a black coating is disposed on the black shading district, and height of the black coating is equal to thickness of the optical film layer.

In another aspect of the present invention, a black tape is disposed on the black shading district, one terminal of the black tape is disposed on a topmost surface of the black coating, and the other terminal of the black tape extends downwards from the topmost surface of the black coating to a bottom of the black coating.

In yet another aspect of the present invention, a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.

According to the present invention, a backlight module comprises a light guide plate (LGP), a light source, and an optical film layer. The light guide plate comprises an incident surface and an emitting surface. The light source is disposed opposite to the incident surface. The optical film layer is disposed on the emitting surface. A black shading district is disposed on a terminal of the optical film layer which is near the light source, for preventing light produced by the light source from entering the optical film layer through the terminal.

In one aspect of the present invention, a black coating is disposed on the black shading district, and height of the black coating is equal to thickness of the optical film layer.

In another aspect of the present invention, a black tape is disposed on the black shading district, one terminal of the black tape is disposed on a topmost surface of the black coating, and the other terminal of the black tape extends downwards from the topmost surface of the black coating to a bottom of the black coating.

In still another aspect of the present invention, the black coating is made of at least one of carbon black, tilox black, metal oxides, metal sulfides, and organic pigments.

In yet another aspect of the present invention, a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.

According to the present invention, a display device comprising a display panel and a backlight module is provided. The backlight module comprises a light guide plate, a light source, and an optical film layer. The light guide plate comprises an incident surface and an emitting surface. The light source is disposed opposite to the incident surface. The optical film layer is disposed on the emitting surface. A black shading district is disposed on as terminal of the optical film layer which is near the light source, for preventing light produced by the light source front entering the optical film layer through the terminal. The display panel is disposed on top of the optical film layer. The display panel comprises a display district, and the black shading district disposed outside of the display district.

In one aspect of the present invention, a black coating is disposed on the black shading district, and height of the black coating is equal to thickness of the optical film layer.

In another aspect of the present invention, a black tape is disposed on the black shading district, one terminal of the black tape is disposed on a topmost surface of the black coating, and the other terminal of the black tape extends downwards from the topmost surface of the black coating to a bottom of the black coating.

In still another aspect of the present invention, the black coating is made of at least one of carbon black, tilox black, metal oxides, metal sulfides, and organic pigments.

In yet another aspect of the present invention, a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.

Differing from the conventional technology, a black shading district is disposed on a terminal of the optical film layer for preventing light produced by a light source from entering the optical film layer in the present invention through the terminal. The design of the present invention is good at preventing light leakage from happening since the light which enters the optical film layer partially through the terminal is blocked off. In this way, display quality of the display device, especially display quality of the display device comprising a narrow bezel is improved.

### BRIEF DESCRIPTION OF THE DRAWINGS

FIG. 1 shows a schematic diagram of the structure of a display device according to a first embodiment of the present invention.

FIG. 2 shows a schematic diagram of the structure of a display device according to a second embodiment of the present invention.

FIG. 3 shows a schematic diagram of the structure of a display device according to a third embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

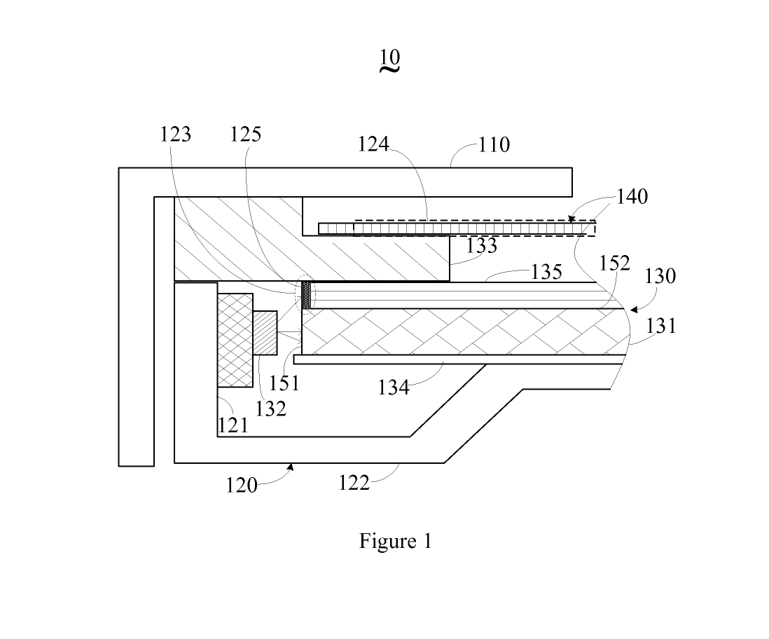

Please refer to FIG. 1 showing a schematic diagram of the structure of a display device 10 according to a first embodiment of the present invention. The display device 10 comprises a frame 110, a back plate 120, a backlight module 130, and a display panel 140. The frame 110 and the back plate 120 form an accommodation space. The accommodation space is used to house the backlight module 130 and the display panel 140.

The back plate 120 comprises a side wall 121 and a bottom 122. The backlight module 130 comprises a light guide plate (LGP) 131, a light source 132, and an optical film layer 135. The LGP 131 is disposed on the bottom 122 and comprises an incident surface 151 and an emitting surface 152. The light source 132 is disposed on the side wall 121. The incident surface 151 and the light source 132 are disposed opposite to each other. The optical film layer 135 is disposed on the emitting surface 152. The optical film layer 135 comprises a terminal near the light source 132, and a black shading district 123 is disposed on the terminal which is near the light source 132. Owing to the black shading district 123, light produced by the light source 132 cannot enter the optical film layer 135 through the terminal.

A black coating 125 is disposed on the black shading district 123. The height of the black coating 125 is equal to the thickness of the optical film layer 135. The black coating 125 is made of at least one of carbon black, tilox black, metal oxides, metal sulfides, and organic pigments. The black coating 125 will absorb light produced by the light source 132 when the light partially enters the optical film layer 135 through the terminal of the optical film layer 135. Since the light cannot enter the optical film layer 135, light leakage will not occur. In this way, display quality of the display device, especially display quality of the display device comprising a narrow bezel, is improved.

Further, the display panel 140 comprises a display district 124. The black shading district 123 is disposed outside of the display district 124 so that light emitted to the display district 124 from the optical film layer 135 is not blocked off. Display quality of the display panel 140 is not negatively affected.

Further, the backlight module 130 comprises a housing 133 and a reflector sheet 134. The frame 110 comprises a side facing the display panel 140, and the housing 133 is disposed on this side. The housing 133 is used to support the display panel 140 and press the optical film layer 135. The reflector sheet 134 is disposed between the bottom 122 and the LGP 131. The reflector sheet 134 is used to reflect light hack to the LGP 131.

The difference between the conventional technology and the embodiment of the present invention is that, the black coating 125 is disposed on the black shading district 123 in the present invention. The black coating 125 will absorb the light when light produced by the light source 132 passes through the terminal of the optical film layer 135. Since the light cannot enter the optical film layer 135, light leakage will not occur. In this way, display quality of the display device, especially display quality of the display device comprising a narrow bezel, will be improved.

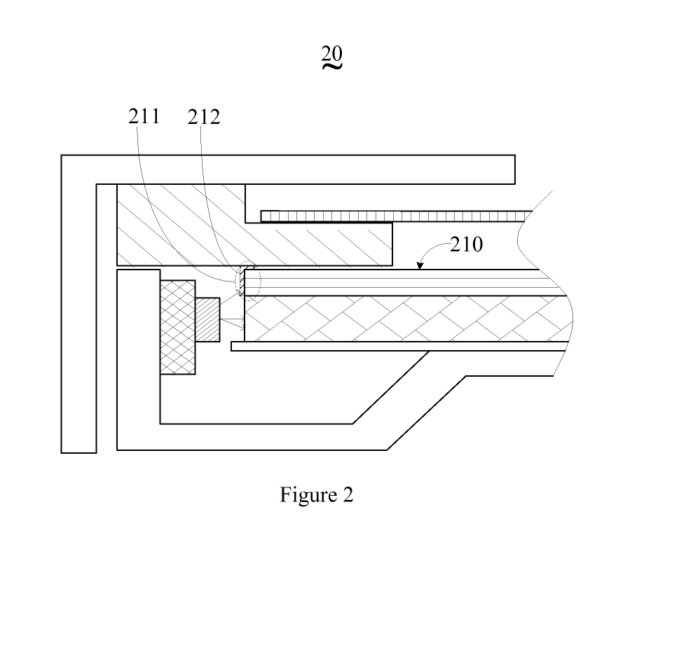

Please refer to FIG. 2 showing a schematic diagram of the structure of a display device 20 according to a second embodiment of the present invention. The difference between the display device 20 and the display device 10 is that, a black tape 212 is disposed in a black shading district 211 of an optical film layer 210 in the display device 20. The black tape 212 comprises two terminals. One terminal of the black tape 212 is disposed on the topmost surface of the optical film layer 210. From the topmost surface of the optical film layer 210, the other terminal of the black tape 212 extends downwards along the terminal of the optical film layer 210 to the bottom of the optical film layer 210.

Likewise, the black tape 212 disposed in the black shading district 211 prevents light produced by the light source from entering the optical film layer 210 through the terminal, so light leakage cannot occur. In this way, display quality of the display device, especially display quality of the display device comprising a narrow bezel, will be improved.

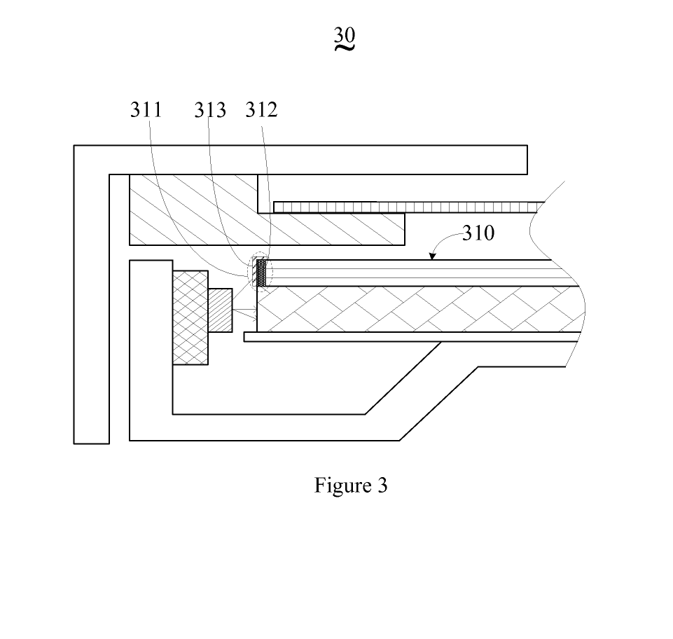

Please refer to FIG. 3 showing a schematic diagram of the structure of a display device 30 according to a third embodiment of the present invention. The difference between the display device 10 and the display device 30 is that, a black coating 312 is disposed in a black shading district 311 of an optical film layer 310 in the display device 30. Further, a black tape 313 is disposed on the black coating 312. The black tape 313 comprises two terminals. One terminal of the black tape 313 is disposed on the topmost surface of the black coating 312. The other terminal of the black tape 312 extends downwards from the topmost surface of the black coating 312 to the bottom of the black coating 112.

Likewise, both of the black coating 312 disposed in the black shading district 311 and the black tape 313 disposed on the black coating 312 prevent light produced by the light source from entering the optical film layer 310 through the terminal, so light leakage cannot occur. In this way, display quality of the display device, especially display quality of the display device comprising a narrow bezel, will be improved.

In conclusion, the black shading district is disposed on the terminal of the optical film layer in the present invention. The black coating and the black tape are disposed on the black shading district. Or, the black tape is also disposed on the black coating. The design of the present invention prevents light produced by the light source from entering the optical film layer through the terminal, so light leakage cannot occur. In this way, display quality of the display device, especially display quality of the display device comprising a narrow bezel, will be improved.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An optical film layer, comprising a terminal on which a black shading district is disposed, for preventing light produced by a light source from entering the optical film layer through the terminal.

2. The optical film layer as claimed in claim 1, wherein a black coating is disposed on the black shading district, and height of the black coating is equal to thickness of the optical film layer.

3. The optical film layer as claimed in claim 2, wherein a black tape is disposed on the black shading district, one terminal of the black tape is disposed on a topmost surface of the black coating, and the other terminal of the black tape extends downwards from the topmost surface of the black coating to a bottom of the black coating.

4. The optical film layer as claimed in claim 1, wherein a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.

5. A backlight module, comprising:
a light guide plate (LGP) comprising an incident surface and an emitting surface;
a light source, disposed opposite to the incident surface; and
an optical film layer, disposed on the emitting surface, wherein a black shading district is disposed on a terminal of the optical film layer which is near the light source, for preventing light produced by the light source from entering the optical film layer through the terminal.

6. The backlight module as claimed in claim 5, wherein a black coating is disposed on the black shading district, and height of the black coating is equal to thickness of the optical film layer.

7. The backlight module as claimed in claim 6, wherein a black tape is disposed on the black shading district, one terminal of the black tape is disposed on a topmost surface of the black coating, and the other terminal of the black tape extends downwards from the topmost surface of the black coating to a bottom or the black coating.

8. The backlight module as claimed in claim 7, wherein the black coating is made of at least one of carbon black, tilox black, metal oxides, metal sulfides, and organic pigments.

9. The backlight module as claimed in claim 5, wherein a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.

10. A display device, comprising a display panel and a backlight module, wherein the backlight module comprises:
a light guide plate (LGP), comprising an incident surface and an emitting surface;
a light source, disposed opposite to the incident surface;
an optical film layer, disposed on the emitting surface, wherein a black shading district is disposed on a terminal of the optical film layer which is near the light source, for preventing light produced by the light source from entering the optical film layer through the terminal;
the display panel disposed on top of the optical film layer, the display panel comprising a display district, and the black shading district disposed outside of the display district.

11. The display device as claimed in claim 10, wherein a black coating is disposed on the black shading district, and height of the black coating is equal to thickness of the optical film layer.

12. The display device as claimed in claim 11, wherein a black tape is disposed on the black shading district, one terminal of the black tape is disposed on a topmost surface of the black coating, and the other terminal of the black tape extends downwards from the topmost surface of the black coating to a bottom of the black coating.

13. The display device as claimed in claim 12, wherein the black coating is made of at least one of carbon black, tilox black, metal oxides, metal sulfides, and organic pigments.

14. The display device as claimed in claim 10, wherein a black tape is disposed on the black shading district, one terminal of the black tape is disposed on a topmost surface of the optical film layer, and the other terminal of the black tape extends downwards along the terminal of the optical film layer from the topmost surface of the optical film layer to a bottom of the optical film layer.
